(19) United States
(12) Patent Application Publication
(10) Pub. No.: US 2026/0360848 A1
(43) Pub. Date: Nov. 12, 2026

(54) LITHIUM-ION BATTERY RECYCLING VIA CUSTOMIZABLE SYSTEMS AND METHODS

(71) Applicants: Siamak Farhad, Copley, OH (US); Dominic Frisone, Akron, OH (US)

(72) Inventors: Siamak Farhad, Copley, OH (US); Dominic Frisone, Akron, OH (US)

(21) Appl. No.: 19/133,151

(22) PCT Filed: Nov. 28, 2023
(86) PCT No.: PCT/US2023/081427

§ 371 Date: May 27, 2025

Related U.S. Application Data
(60) Provisional application No. 63/428,213, filed on Nov. 28, 2022.

(51) Int. Cl. H01M 10/54; B09B 3/80; B09B 101/16

(52) U.S. Cl. CPC H01M 10/54; B09B 3/80; B09B 2101/16

(57) ABSTRACT

A method of recycling lithium-ion battery material includes steps of providing the lithium-ion battery material, the lithium-ion battery material having a variety of properties; reducing the size of the lithium-ion battery material; mixing, after the step of reducing the size, the lithium-ion battery material with a solvent, wherein the solvent is customized via a model, wherein the variety of properties of the lithium-ion battery material are inputs for the model; separating the solvent from the lithium-ion battery material; and collecting a product following the step of separating the solvent, wherein the product is a component of the lithium-ion battery material. A further method includes combining lithium-ion battery material with a heavy liquid.

### CROSS-REFERENCE TO RELATED APPLICATIONS

This application claims the benefit of U.S. Provisional Application No. 63/428,213, filed on Nov. 28, 2022, which is incorporated herein by reference.

### FIELD OF THE INVENTION

Embodiments of the present invention relate to lithium-ion battery recycling. One or more embodiments relate to customizable systems and methods, such as customizing one or more of a heavy liquid, a solvent blend, and a machine assembly, for lithium-ion battery recycling.

### BACKGROUND OF THE INVENTION

The applications of lithium-ion batteries (LIB's) range from consumer electronics to automotive, healthcare, and renewable/grid energy storage systems. The use of lithium-ion batteries is significantly increasing in the world. As one example, the production and usage of these batteries has been increased relative to electric vehicles (EV's) and renewable energy storage. Lithium-ion batteries produced today will generally be retired after about 10 years.

This raises the question of how to deal with the retired lithium-ion batteries. If the lithium-ion batteries are landfilled, several environmental problems would be expected. A first issue is contamination as chemicals found in batteries may leak from the casing once the battery is in a landfill and contaminate the area and groundwater. Another issue is safety as the landfilled lithium-ion batteries may catch fire and may cause an explosion. A further item is sustainability as several rare earth materials, such as lithium and cobalt, would be wasted in landfilled lithium-ion batteries.

Even conventional efforts to recycle lithium-ion batteries, which generally include centralized recycling sites, present issues. A first issue is the general requirement to transport the lithium-ion batteries a relatively long distance to the central recycling sites. This increases the cost of recycling because transportation is expensive. The transported lithium-ion batteries may also catch fire or explode during the transportation.

A further issue with centralized recycling sites is that different types (e.g., different chemistries and/or technologies) of lithium-ion batteries are recycled together in the centralized recycling sites without sorting them due to logistical difficulties. This makes the direct recycling method for centralized recycling sites economically unjustified since all types of energy storage materials are mixed during the recycling and since it is very costly to separate, for example, the mixed cathode materials after recycling. Centralized recycling sites are also highly inefficient and can lead to human exposure to chemicals.

There remains a need in the art for improved recycling of lithium-ion batteries.

### SUMMARY OF THE INVENTION

A first embodiment of the present invention provides a method of recycling lithium-ion battery material, the method comprising steps of providing the lithium-ion battery material, the lithium-ion battery material having a variety of properties; reducing the size of the lithium-ion battery material; mixing, after the step of reducing the size, the lithium-ion battery material with a solvent, wherein the solvent is customized via a model, wherein the variety of properties of the lithium-ion battery material are inputs for the model; separating the solvent from the lithium-ion battery material; and collecting a product following the step of separating the solvent, wherein the product is a component of the lithium-ion battery material.

A second embodiment of the present invention provides a method as in any embodiment above, wherein the separating the solvent comprises steps of sieving, followed by filtrating, and followed by precipitating.

A third embodiment of the present invention provides a method as in any embodiment above, wherein the product comprises either black mass or electrode active material.

A fourth embodiment of the present invention provides a method as in any embodiment above, wherein the lithium-ion battery material comprises electrode scrap material, wherein the step of reducing the size produces standardized size electrode scrap material.

A fifth embodiment of the present invention provides a method as in any embodiment above, wherein the lithium-ion battery material comprises whole battery modules, wherein the step of reducing the size is a step of shredding.

A sixth embodiment of the present invention provides a method as in any embodiment above, wherein the solvent is selected from dihydrolevoglucosenone (Cyrene), dimethylsulfoxide (DMSO), N-methyl-2-pyrrolidinone (NMP), Rhodiasolv® PolarCleana, tetrahydrofuran (THF), triacetin, triethyl phosphate (TEP), ethylene glycol (EG), acetyl tributyl citrate (ABTC), triethylene glycol diacetate (TEGDA), methyl ethyl ketone (MEK), propylene carbonate (PC), γ-Butyrolactone (GBL), dimethyl isosorbide (DMI), benzyl alcohol, isopropyl palmitate, ethyl laurate, glycerol, diacetin, sodium dodecyl sulfate (SDS), sodium lauryl sulfate (SLS), dimethyl ethylsuccinate, and combinations thereof.

A seventh embodiment of the present invention provides a method as in any embodiment above, wherein the model includes selecting a solvent blend from a database of solvents, wherein the database of solvents includes over twenty total solvents, wherein the model selects up to five solvents of the over twenty solvents for the solvent blend.

An eighth embodiment of the present invention provides a method as in any embodiment above, wherein user requirements are inputs for the model, wherein the user requirements comprise cost, quality, throughput, footprint, uptime, and combinations thereof.

A ninth embodiment of the present invention provides a method as in any embodiment above, wherein components of the machine assemblies which perform the steps of reducing the size, mixing, and separating are inputs for the model.

A tenth embodiment of the present invention provides a method comprising steps of providing the lithium-ion battery material, wherein the lithium-ion battery material includes a first component with a relatively lower density and a second component with a relatively higher density; combining the lithium-ion battery material with a heavy liquid, wherein the heavy liquid has a density in between the relatively lower density and the relatively higher density, such that the heavy liquid is in between the first component as an upper product and the second component as a lower product; and collecting the first component as the upper product and collecting the second component as the lower product.

An eleventh embodiment of the present invention provides a method as in any embodiment above, wherein the lithium-ion battery material comprises black mass, wherein the first component with the relatively lower density comprises anode active material, wherein the second component with the relatively higher density comprises cathode active materials.

A twelfth embodiment of the present invention provides a method as in any embodiment above, wherein the heavy liquid comprises lithium heteropolytungstate (LHPW) (Li₆H₂[PW₁₂O₄₀]), zinc chloride (ZnCl₂), sodium polytungstate (STP) (Na₆[H₂W₁₂O₄₀]), sodium iodide (NaI), or combinations thereof.

A thirteenth embodiment of the present invention provides a method as in any embodiment above, wherein the heavy liquid comprises sodium iodide (NaI), barium sulfate (BaSO₄), strontium carbonate (SrCO₃), or combinations thereof.

A fourteenth embodiment of the present invention provides a method as in any embodiment above, wherein the lithium-ion battery material comprises different cathode active materials, wherein the first component with the relatively lower density comprises a first cathode active material, wherein the second component with the relatively higher density comprises a second cathode active material.

A fifteenth embodiment of the present invention provides a method as in any embodiment above, wherein the different cathode active materials comprise LiFePO₄ (LFP), LiMn₂O₄ (LMO), LiNiCoAlO₂ (NCA), LiNiCoMnO₂ (NMC), and LiCoO₂ (LCO) (ρ=5.05 g/cm³).

A sixteenth embodiment of the present invention provides a method as in any embodiment above, wherein the heavy liquid comprises multistage heavy liquid separation steps utilizing barium sulfate (BaSO₄), strontium carbonate (SrCO₃), bismuth subnitrate (Bi₅O(OH)₉(NO₃)₄), and Clerici Solution (mixture of thallium malonate (TIC₃H₃O₄) and thallium formate TlHCOO).

A seventeenth embodiment of the present invention provides a method as in any embodiment above, wherein the heavy liquid is diluted by water, other solvents, other dilutants, or combinations thereof.

An eighteenth embodiment of the present invention provides a method as in any embodiment above, wherein the lithium-ion battery material is produced by a system comprising components of a shredder, an eddy current separator, a mixer, a vibrating conveyor, and a filter press.

A nineteenth embodiment of the present invention provides a method as in any embodiment above, wherein the lithium-ion battery material is produced by a system comprising components of a shredder, a mixer, a vibrating table, and a filter press.

A twentieth embodiment of the present invention provides a method as in any embodiment above, wherein the method occurs within a modular recycling assembly.

A twenty-first embodiment of the present invention provides a method as in any embodiment above, wherein the method occurs within a battery manufacturing facility.

### DETAILED DESCRIPTION OF ILLUSTRATIVE EMBODIMENTS

Advantages of the present invention will become better understood with regard to the following description, appended claims, and accompanying drawings wherein:

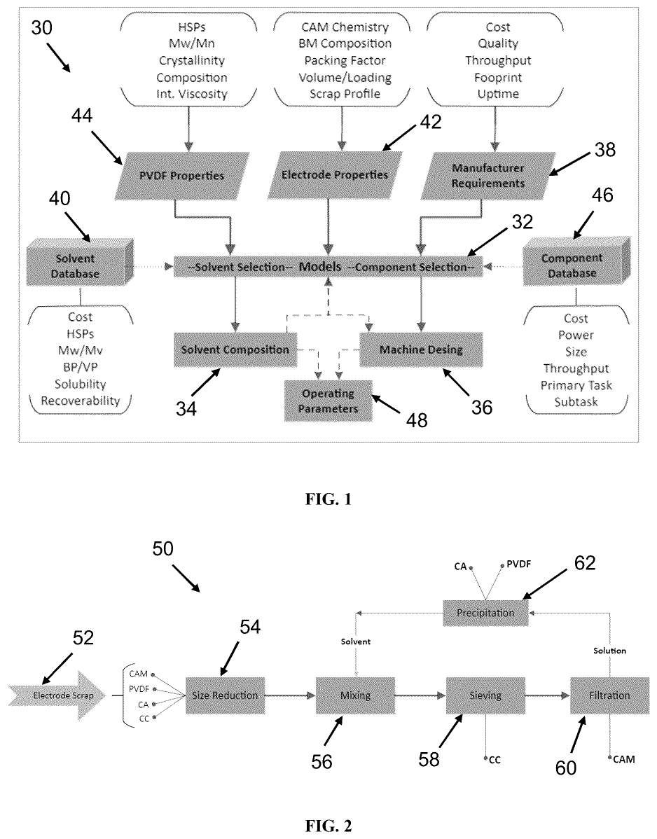

FIG. 1 is a flowchart showing inputs and outputs for a lithium-ion battery recycling method, according to one or more embodiments of the invention;

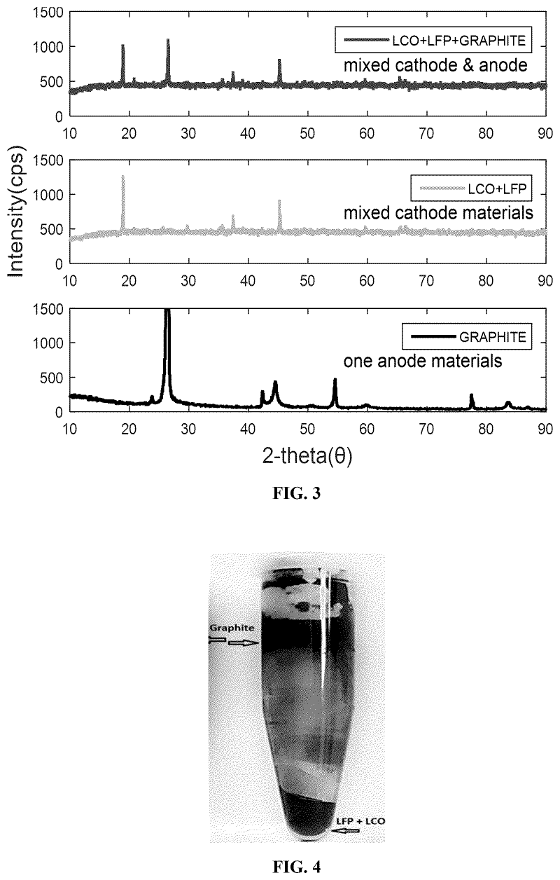

FIG. 2 is a schematic of mechanical aspects for a lithium-ion battery recycling method, according to one or more embodiments of the invention;

FIG. 3 is a graph showing X-ray diffraction results for lithium-ion battery component separation, according to one or more embodiments of the invention;

FIG. 4 is a photo showing LiFePO₄ (LFP) and LiCoO₂ (LCO) cathode active materials separated from the graphite anode active material, according to one or more embodiments of the invention;

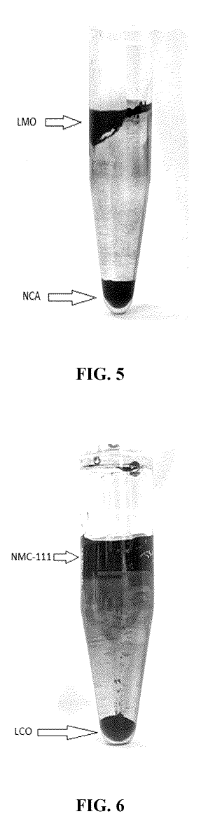

FIG. 5 is a photo showing LiMn₂O₄ (LMO) separated from LiNiCoAlO₂ (NCA), according to one or more embodiments of the invention;

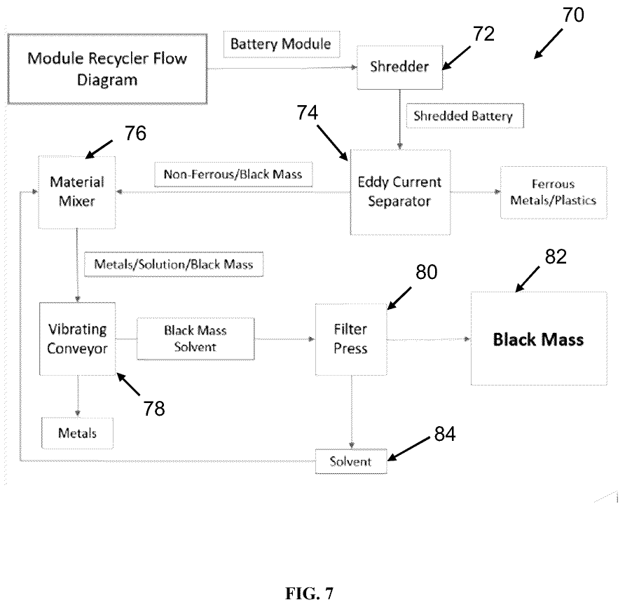

FIG. 6 is a photo showing LiNiCoMnO₂ (NMC) separated from LiCoO₂ (LCO), according to one or more embodiments of the invention;

FIG. 7 is a flowchart of a method of obtaining black mass, according to one or more embodiments of the invention;

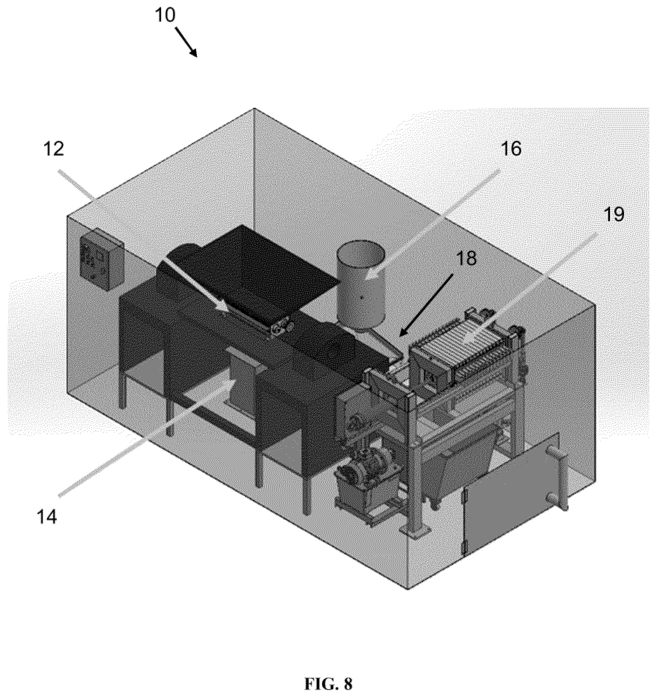

FIG. 8 is a schematic of a modular recycling assembly, according to one or more embodiments of the invention;

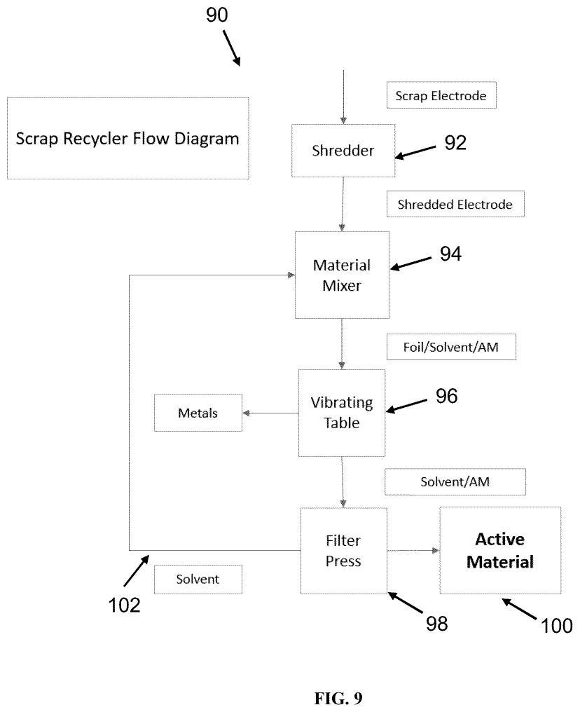

FIG. 9 is a flowchart of a method of obtaining active material, according to one or more embodiments of the invention; and

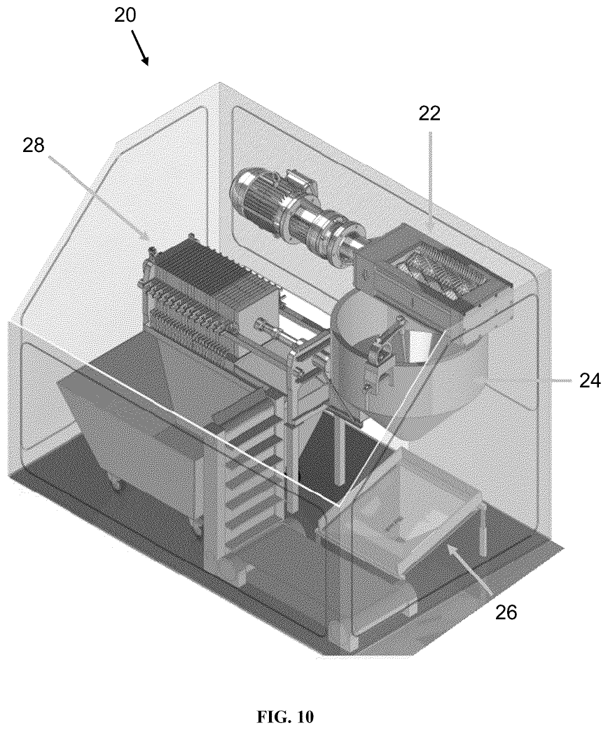

FIG. 10 is a schematic of an alternative modular recycling assembly, according to one or more embodiments of the invention.

### DETAILED DESCRIPTION OF ILLUSTRATIVE EMBODIMENTS

One or more embodiments of the present invention relate to lithium-ion battery recycling. The methods and assemblies disclosed herein relate to direct methods for recycling lithium-ion batteries, which may also be referred to as physical methods. Physical methods are generally the most cost effective and environmentally friendly methods for recycling lithium-ion batteries. Advantageously, embodiments of the present invention relate to customizable systems and methods. That is, one or more of a heavy liquid, a solvent blend, and a machine assembly, can be customized for recycling a particular lithium-ion battery material and collecting a sub-component therefrom. One or more embodiments relate to customizable solvent blends for lithium-ion battery recycling. One or more embodiments relate to customizable heavy liquids for lithium-ion battery recycling. One or more embodiments relate to customizable machine assemblies for lithium-ion battery recycling.

One or more embodiments of the invention relate to modular recycling assemblies. Certain embodiments of modular recycling assemblies are shown in the Figures, particularly FIG. 8 and FIG. 10, which assemblies are generally shown by the numerals 10 and 20. Other designs for the modular recycling assemblies are also suitable according to the disclosure herein.

One or more embodiments of the invention relate to methods for recycling lithium-ion batteries which utilize the modular recycling assemblies. Certain embodiments of methods for recycling lithium-ion batteries are shown in the Figures, particularly FIG. 1, FIG. 2, FIG. 7, and FIG. 9, which methods are generally shown by the numerals 30, 50, 70, and 90. Other methods for recycling lithium-ion batteries are also suitable according to the disclosure herein.

The modular recycling assemblies (e.g., assemblies 10, 20), which may also be referred to as local recycling sites or small recycling machines, are adapted for recycling lithium-ion batteries and are intended as a replacement for conventional centralized recycling sites. Advantageously, the modular recycling assemblies are customizable for different chemistries and technologies of lithium-ion batteries. In contrast to conventional centralized recycling sites generally being limited to a single process for recycling all types of lithium-ion batteries, the customizable modular recycling assemblies disclosed herein can be adapted for a variety of types of lithium-ion batteries, which helps to improve the recycling efficiency.

The modular recycling assemblies also help to, for example, reduce or eliminate the transportation costs associated with centralized recycling sites. Instead of a relatively large, centralized recycling system, the modular recycling assemblies can be relatively smaller and therefore can be used at more local recycling sites. The modular recycling assemblies further help to, for example, improve safety relative to centralized recycling sites. One way of improving safety is the modular recycling assemblies being fully or semi-automated, rather than a manual recycling system, which reduces or eliminates personal exposure to chemicals. Examples of users who might utilize the modular recycling assemblies include battery manufacturers, automakers, and renewable energy storage system industries. The various users can utilize modular recycling assemblies particularly adapted to recycle their own lithium-ion batteries. This again helps to further improve recycling efficiency as the modular recycling assemblies can be set to a specific technology.

Lithium-ion batteries (LIB's) are storage systems for electrical energy. Their relatively high energy density, high power density, and long lifespan led to making them a top candidate for portable electronics, electric vehicles, and renewable energy storage. Commercial lithium-ion batteries generally include six components: (1) anode (i.e., negative) electrode, (2) cathode (i.e., positive) electrode, (3) electrolyte, (4) separator, (5) current collectors for positive and negative electrodes, which are usually aluminum and copper foils, respectively, and (6) the battery casing, which is usually stainless steel for cylindrical LIBs and polymer coated aluminum for pouch/prismatic lithium-ion batteries.

The negative and positive electrodes are usually made of three materials: the active material for storage of lithium, the conductive material to enhance the electron conductivity of electrode, and the binder to bond the active and conductive materials, and to adhere the electrode to the current collector. An exemplary binder is polyvinylidene fluoride (PVDF), though further binder materials for batteries may be generally known to the skilled person and suitable for use with the systems and methods disclosed herein.

Among anode active materials, graphite is generally common because of its relatively high energy density (372 mAh/g), good mechanical and chemical stabilities, and relatively low cost. Another anode active material is Li₄Ti₅O₁₂ (LTO), which is a promising anode active material because of its constant charge/discharge profile at 1.5 V versus lithium and its excellent Li-insertion/extraction reversibility with no structural change. Still further anode active materials for batteries may be generally known to the skilled person and suitable for use with the systems and methods disclosed herein.

For cathode active materials, LiCoO₂ (LCO) can be utilized in certain batteries due to its high specific energy. Other cathode active materials for batteries include LiFePO₄ (LFP), LiMn₂O₄ (LMO), LiNiₓCo_{y}Al_{(1-x-y)}O₂ (NCA), and LiNiₓMn_{y}Co_{(1-x-y)}O₂ (NMC). Still further cathode active materials for batteries may be generally known to the skilled person and suitable for use with the systems and methods disclosed herein. Each cathode active material has certain advantages and disadvantages, leading to a variety of materials utilized across various lithium-ion batteries.

The electrolyte in lithium-ion batteries is responsible for transferring lithium ions between the cathode and anode active materials. Most commercial lithium-ion batteries use organic liquid electrolytes because of their relatively wide electrochemical stability. An organic liquid electrolyte is comprised of a lithium salt, such as lithium hexafluorophosphate (LiPF₆), dissolved in an organic solvent.

The separator is an electron non-conductive material that separates the positive electrode from the negative electrode to prevent the short circuit between them, while allowing for rapid transport of ionic charges between the negative and positive electrodes. In most lithium-ion batteries, separators are made of either microporous polymeric films or nonwoven fabrics. The microporous polymeric films (e.g., polyethylene (PP)) may be the preferred separator because of their thermal and mechanical stabilities.

Among all components of lithium-ion batteries, the cathode active material is usually the most expensive as it may value up to 40% of the total material cost of lithium-ion batteries. This has led to attempts at improving the energy density/electrode performance while reducing the cost of cathode. Certain attempts have included the combination/mixture of two or three cathode active materials. For example, the cathode mixture of LMO and NCA has been utilized. NCA shows a high energy density and a good lifetime, but shows poor thermal stability at elevated temperatures. On the other hand, the LMO shows a better thermal stability, higher nominal voltage, higher power density, and lower cost, but has a lower energy density. Therefore, the performance of the cathode can be engineered when NCA and LMO are blended and the cathode is made from a mixture of two active materials. Another blended electrode example of two cathode active materials is LMO and NMC. The low capacity of LMO is increased when it is blended with NMC. A further example is a ternary blend of NMC, LMO, and LMFP, where a blend of about 75% NMC, about 12.5% LMFP, and about 12.5% LMO is comparable with 100% NMC.

As suggested above, this blending of materials is utilized to either reduce the cost or enhance the electrochemical performance of the cathode. This blending adds to the complexity of recycling the materials. Embodiments of the present invention relate to systems and methods for recycling the blended cathode materials that are obtained from recycling of lithium-ion batteries using the physical recycling method.

One advantage of the physical recycling method is that the electrode active materials can be separated without changing the morphology of materials. Hence, the recycled electrode materials can be regenerated and reused to make new lithium-ion batteries. In certain embodiments, the physical method generally includes recycling all types of lithium-ion batteries together without first sorting them out based on the battery chemistry. In other embodiments, the lithium-ion batteries can be sorted before recycling. Though, sorting lithium-ion batteries is usually not logistically practical, and the obtained cathode active materials from recycling are therefore a blend of different active materials. One or more embodiments of the present invention include obtaining a blend, which may be referred to as a mixture, of cathode types. This can include obtaining a mixture of one or more of LFP, LMO, NMC, NCA, and LCO. As discussed further herein, one or more embodiments also relate to separating these components from the mixture. The separation process can be performed in an ideal (i.e., 100%, or about 100%, of each component to be separated) manner. In these embodiments, the obtained pure single regenerated cathode active materials can be used to make new lithium-ion batteries. In other embodiments, the separation process can be performed with an efficiency of less than 100%, such as about 95%, or about 90%, or about 80%, or about 70%, or about 60%, or about 50%. In these embodiments, the single regenerated cathode active material that contains a little of other types of cathode active materials can be used to make new lithium-ion batteries. In still other embodiments, no separation step is performed, and the obtained material with various types of cathode active materials can be regenerated together and used to make new batteries.

With further reference to FIG. 8 and FIG. 7, further description of the modular recycling assembly 10 and method 70 is now provided. The modular recycling assembly 10 is generally adapted to perform the method 70. Modular recycling assembly 10 and method 70 have a main input of whole battery packs, which may be referred to as battery modules, in order to obtain a black mass product output. The major components include a shredder 12, an eddy current separator 14, a mixer 16, a vibrating conveyor 18, and a filter press 19. While FIG. 8 shows certain positioning and layout for these components, other suitable positions and layouts may be suitable. For example, motors to drive certain components may be external or internal.

The battery modules are fed to shredder 12 which performs a step 72 of shredding the batteries into small pieces. The shredder 12 should work based on cutting, rather than impacting, or should have cutting as the dominant mechanism. This can include scissoring or crushing with knife-type blades. In one or more embodiments, this step 72 can be done in air. If thermal management is required, in other embodiments a solvent can be used to cool down the temperature to prevent melting current collectors' foils and plastics parts. A portion of electrode materials separation can be also done in parallel to cooling. The solvent can be water-based (with or without additives) or other types of liquids. The screen (i.e., mesh size) of the shredder can be selected to achieve a desired size for the shredded battery output. The shredder design may be different for batteries that have a metal casing (e.g., steel) or a pouch casing (e.g., aluminum covered by polymer layers). In one or more embodiments, the batteries can be cooled, such as by cryogenically freezing, before step 72 to make the batteries more brittle.

The shredded batteries, which may be referred to as larger solid pieces, enter eddy current separator 14 which performs a step 74 of separating. Step 74 includes separating a first stream of ferrous materials and plastics from a second stream of non-ferrous materials and ‘black mass’ components. Exemplary components of the non-ferrous materials/black mass stream include nickel, aluminum, and copper materials. The non-ferrous materials/black mass stream is provided to mixer 16. In one or more embodiments, the ferrous materials and plastics are further separated from each other. The iron may be removed with a drum magnet. In one or more embodiments, a rotating screen drum may be utilized for further separation of components within step 74.

Within mixer 16, the non-ferrous materials/black mass stream is combined with a solvent in a mixing step 76. The solvent may be provided as one or more of a fresh stream (not shown) and a recycle stream (i.e., a recycle step 84). The properties of the solvent, which can be a blend, should be tailored for the desired properties based on the particular battery materials. Each solvent has certain properties and the desired properties can be obtained by a particular combinations of solvents. Further details of the solvent will be provided herein below.

The solution from mixing step 76 can then be provided to vibrating conveyor 18 for a further separation step 78. Further separation step 78 should include separating certain metals (e.g., nickel, aluminum, and copper) from a black mass and solvent solution, which may be referred to as a slurry. A filter press 19, which in other embodiments might be a centrifugal separator, takes the slurry material and separates the solvent liquid from the black mass product, which may be referred to as a thicker slurry or as separated electrode materials, in a separation step 80. As suggested above, the solvent can then be recycled and recirculated in a recycle step 84 back to the mixing step 76.

The black mass product is collected in a collection step 82, which may include further separation of the materials, such as separating the anode and cathode materials from each other. The further separation can be via a density separation technique. This may be done by sorting the materials by their density utilizing a liquid of a particular density, which may be referred to as a heavier liquid, heavy liquid, or separation liquid. The heavy liquid should have a density in between the components desired to be separated, which is shown in FIGS. 4 to 6. For example, the anode materials can have a relatively lower density of about 2.27 g/cm³ and the cathode materials will have relatively higher densities, such as about 3.60 g/cm³ and greater. This provides the opportunity of using the density separation method, which should include any necessary settling time for the components to separate. An exemplary heavy liquid for density separation is sodium polytungstate (SPT). The heavy liquid will generally be in between a lower product with the relatively higher density and an upper product with the relatively lower density. The lower product, heavy liquid, and upper product can then be collected by suitable techniques.

The heavy liquid separation can employ a customizable heavy liquid to effectively separate anode and cathode active materials from the black mass (i.e., a mixture of electrode active materials) or filter cake produced during lithium-ion battery recycling. This tailored heavy liquid and its adjusted temperature and viscosity, which can be a single liquid or a blend of different liquids, features a density positioned between the densities of the active materials. In one or more embodiments, the density can be closer to the lower-density material. The method enables a broader range of heavy liquid selection. The heavy liquid can be targeted for being both effective for separation and easier to recover, while remaining environmentally friendly, non-toxic, and ensuring no damage to the electrode materials during separation. In one more embodiments, this heavy liquid method can be adapted to separate plastic parts of the recycled battery by adjusting the density to about 1 to 1.5 g/cm³.

Exemplary heavy liquids include lithium heteropolytungstate (LHPW) (Li₆H₂[PW₁₂O₄₀]), zinc chloride (ZnCl₂), sodium polytungstate (STP) (Na₆[H₂W₁₂O₄₀]), sodium iodide, (NaI), barium sulfate (BaSO₄), and strontium carbonate (SrCO₃). The heavy liquid can be a blend of these components. The heavy liquid can be mixed/diluted in water or other solvents/dilutants. The heavy liquid can include adding anti-corrosive additives such as sodium molybdate, potassium molybdate, sodium phosphate, zinc phosphate, amine-based compounds, and the like. The blend tailoring can be done based on the desired density, viscosity, environmental aspects, recoverability, safety, corrosivity, and cost of the heavy liquid formula.

In one or more embodiments, a mixture of graphite (G) anode active material (ρ=2.2 g/cm³) and LiFePO₄ (LFP), LiMn₂O₄ (LMO), LiNiCoAlO₂ (NCA), LiNiCoMnO₂ (NMC) and LiCoO₂ (LCO) cathode active materials (ρ ranges from 3.7 to 5.05 g/cm³) can be separated using lithium heteropolytungstate (LHPW) (Li₆H₂[PW₁₂O₄₀]), zinc chloride (ZnCl₂), sodium polytungstate (STP) (Na₆[H₂W₁₂O₄₀]), or sodium iodide (NaI) (ρ=3.67 g/cm³) heavy liquids, which can be a blend of them mixed/diluted in water or other solvents/dilutants and with anti-corrosive additives. For very fine particles, the lower viscosity may be preferred which can be addressed by zinc chloride or NaI which offers the lowest density among the base-heavy liquids of LHPW, STP, NaI, and ZnCl₂. In the case of corrosion of active materials, aluminum and the recycling machine parts (e.g., stainless steel or other metals/materials), LHPW or NaI may be preferred. The separation process can be done at room temperature. In other embodiments, the temperature can be increased which can decrease the viscosity and can affect the separation time. FIG. 4 shows LFP and LCO cathode active materials separated from the graphite anode active material using a tailored blend according to these embodiments. FIG. 3 shows XRD (X-ray diffraction) results showing the effectiveness of the separation.

In one or more embodiments, a mixture of lithium titanate (LTO) Li₄Ti₅O₁₂ anode active material (ρ=3.5 g/cm³) and LiFePO₄ (LFP), LiMn₂O₄ (LMO), LiNiCoAlO₂ (NCA), LiNiCoMnO₂ (NMC) and LiCoO₂ (LCO) cathode active materials (ρ ranges from 3.7 to 5.05 g/cm3) can be separated using sodium iodide (NaI), barium sulfate (BaSO₄) (ρ=4.5 g/cm³), strontium carbonate (SrCO₃) (ρ=3.74 g/cm³), or a blend mixed/diluted by water or other solvents/dilutants. The separation process can be done at room temperature. In other embodiments, the temperature can be increased which can decrease the viscosity and can affect the separation time. FIG. 5 shows the separation of LMO and NCA using a tailored blend according to these embodiments.

Customizable heavy liquids can also be employed to effectively separate different cathode active materials from each other after separation of the anode active materials from the black mass which is produced during lithium-ion battery recycling. This tailored heavy liquid and its adjusted temperature, which can be a single liquid or a blend of different liquids features a density positioned between the densities of the targeted cathode active materials. In one or more embodiments, the density can be closer to the lower-density material.

In one or more embodiments, a mixture of LiFePO₄ (LFP) (ρ=3.7 g/cm³), LiMn₂O₄ (LMO) (ρ=4.2 g/cm³), LiNiCoAlO₂ (NCA) (ρ=4.45 g/cm³), LiNiCoMnO₂ (NMC) (ρ=4.7 g/cm³), LiCoO₂ (LCO) (ρ=5.05 g/cm³), can be separated by a multistage heavy liquid separation process based on the base heavy liquids of barium sulfate (BaSO₄) (ρ=4.5 g/cm³), strontium carbonate (SrCO₃) (ρ=3.74 g/cm³), bismuth subnitrate (Bi₅O(OH)₉(NO₃)₄) (ρ=4.94 g/cm³), Clerici Solution (mixture of thallium malonate (TlC₃H₃O₄) and thallium formate TlHCOO) (ρₘₐₓ=5.1 g/cm³), or a blend of them that can be diluted by water or other solvent/diluents to achieve the desired properties. Several protective additives can be added to the blend, for example, the anti-corrosion additives of sodium molybdate, potassium molybdate, sodium phosphate, zinc phosphate, amine-based compounds, and the like.

First, the LFP can be separated by adjusting the heavy liquid blend density to the range of 3.7 and 4.2 g/cm³. Then, LMO can be separated by adjusting the heavy liquid blend density to the range of 4.2 and 4.45 g/cm³. Then, NCA can be separated by adjusting the heavy liquid blend density to the range of 4.45 and 4.7 g/cm³. Finally, NMC and LCO can be separated by adjusting the heavy liquid blend density to the range of 4.7 and 5.1 g/cm³, which is shown in FIG. 6. In addition to the dilution level, the composition of the blend can be different, ranging from only one base heavy liquid to a blend of multiple heavy liquids.

The heavy liquid separation can be done using devices such as decanters, hydrocyclones, cyclones, sedimentation tanks, electrostatic separators, magnetic separators, nanoparticle separators, field-flow fractionation systems, filter press, and the like. The particular device utilized might depend on the size of particles for separation, the desired time for separation, precision, level of control, the cost, operation, and maintenance fee of the device. A further example of a suitable device for the heavy liquid separation is a sorticanter, which may be referred to as a centrifugal separator, which can have adjusting screw shapes, length, and rotational speed, and can separate two dense active materials types which are different in density.

Once separated, the anode and cathode materials can be sent into a heater or dryer (not shown), where they are dried. The dried anode and cathode materials can be packaged for sending for materials regeneration. One example is a heater which slowly heats the materials through a pizza oven-like conveyor to dry out the electrode materials. The other separated materials (plastics and metals) may also be dried similarly. An exemplary drying time is 10 minutes drying.

Where all components are separated, the modular recycling assembly outputs will be (1) anode materials, (2) cathode materials, (3) iron parts, (4) plastics parts, (5) nickel, copper, and aluminum metals. The nickel, copper, and aluminum metals can be utilized together or can be further separated.

In one or more embodiments, the modular recycling assembly can have a washing system to make it ready to recycle lithium-ion batteries with another chemistry. In one or more embodiments, the modular recycling assembly can be a skid mounted machine.

With further reference to FIG. 10 and FIG. 9, further description of the modular recycling assembly 20 and method 90 is now provided. The modular recycling assembly 20 is generally adapted to perform the method 90. Modular recycling assembly 20 and method 90 may be referred to as a separation section. Modular recycling assembly 20 and method 90 have a main input of manufacturing scrap, which may be referred to as scrap electrodes, in order to obtain an active material product output. That is, modular recycling assembly 20 and method 90 generally serve to take the scrap materials generated by lithium-ion battery manufacturers as an input in order recycle and return the ‘waste’ cathode materials in the scrap materials back to the supply chain. The major components include a shredder 22, a mixer 24, a vibrating table 26, and a filter press 28. While FIG. 10 shows certain positioning and layout for these components, other suitable positions and layouts may be suitable. For example, motors to drive certain components may be external or internal. An

The scrap materials are fed to shredder 22 which performs a step 92 of shredding the batteries into small pieces. The details of shredder 22 and step 92 are otherwise similar to shredder 12 and step 72 disclosed above.

The shredded scrap materials, which may be referred to as shredded electrodes, are provided to mixer 24. Within mixer 24, the shredded materials are combined with a solvent in a mixing step 94. The solvent may be provided as one or more of a fresh stream (not shown) and a recycle stream (i.e., a recycle step 102). The details of mixer 24, step 94, and the solvent are otherwise similar to shredder 12 and step 76 disclosed above, and the solvent details disclosed elsewhere herein.

The stream from mixing step 94 can then be provided to vibrating table 26, which can also be a vibrating conveyor, for a further separation step 96. Further separation step 96 should include separating certain metals (e.g., nickel, aluminum, and copper) from an active materials and solvent solution, which may be referred to as a slurry. A filter press 28, which in other embodiments might be a centrifugal separator, takes the slurry material and separates the solvent liquid from the active material product, which may be referred to as separated active materials, in a separation step 98. As suggested above, the solvent can then be recycled and recirculated in a recycle step 102 back to the mixing step 94.

The active material product is collected in a collection step 100. The active material product can be sent into a heater or dryer (not shown), where they are dried. The active materials can be packaged for sending for materials regeneration. Other drying and collection details are similar to as disclosed above.

In one or more embodiments, particularly for collecting cathode active materials, the solvent for a mixing and separation step may be a mixture of water and dimethylsulfoxide (DMSO). In one or more embodiments, a mixture of water and dimethylsulfoxide. Is at a volume ratio of about 1:1, or about 1.5:1, about 2:1, or about 2.5:1. The mixture of water and dimethylsulfoxide can be used for effective separation of cathode active materials from the aluminum current collector. The mixture of water and dimethylsulfoxide can dissolve the binder (e.g., polyvinylidene fluoride (PVDF)), such as for active material separation.

In one or more embodiments, a collected product may be further treated, which may be referred to as a rejuvenation process. Exemplary further rejuvenation steps include washing (e.g., with demineralized water), drying the material (i.e., particles), and then a powder deagglomeration device to obtain the final product. Exemplary powder deagglomeration devices include ball mills and pulverizers.

As mentioned above, one or more embodiments include recovering and recirculating the solvent. The solvent recirculation system may include a filter, a storage tank, a pump, and a heater. The heater may increase the solvent temperature for more effective separation when recycled. In other embodiments, the solvent recirculation system can include a cooling system. In one or more embodiments, such as for recovering DMSO as the solvent, the binder (e.g., PVDF) can be floated on the surface of the solvent mixture (e.g., DMSO/Water) after cooling the mixture to a freezing point temperature.

Further details of customization are now disclosed. The customization can include one or more of customizing a solvent blend and customizing a machine assembly.

Solvent blends can be tailored, which may be referred to as customized, for the particular materials to be recycled. With reference to FIG. 9, in one or more embodiments, a solvent blend can be customized for direct recycling of cathode active material (CAM) from lithium-ion battery manufacturing scrap. By eliminating the use of hazardous materials, the customizing of solvent blends provides a non-toxic and cost-effective recycling method, thereby addressing and exceeding the standards for sustainable practices within the industry. The customizing of solvent blends can utilize a closed loop recycling approach, ensuring the recovered CAM remains on-site and all other constituents are recovered and sent to highest value secondary uses, bolstering supply chain security, returning maximum economic value, and reinforcing domestic battery production resilience. While embodiments disclosed herein relate to modular assemblies, this approach of customizing solvents can also be employed within a battery manufacturing facility.

Solvent blends can be meticulously analyzed through a sophisticated machine learning model. The model can be capable of selecting and quantifying up to five solvents from a database of over twenty total solvents, or from about twenty total solvents. This system flexibly accommodates a range of solvent blend compositions. In one or more embodiments, the customized solvent blend can utilize dimethyl sulfoxide (DMSO) exceeding 50% volume due to its excellent solubility properties for binders (e.g., polyvinylidene fluoride (PVDF)).

For customizing a solvent blend, the particular solvents and their proportions can be selected from a database based on their ability to perform two functions or capabilities. A first capability is to disrupt intermolecular bonds between the binder (e.g., PVDF), CAM, and aluminum current collector primarily through dissolution and inhibitory bonding mechanisms. Secondarily, the blend should be recoverable via non-solvent induced phase separation (NIPS) processes found in the filtration membrane industry. Recovery of the solvent blend requires the dissolved binder to be extracted already. By using the NIPS process, the resulting binder (e.g., PVDF) can be converted into a high-value product, turning the largest cost of operating the system into a revenue generator. Customizing a solvent blend, and the model utilized therein, should strike a balance between the cost and efficiency of separation, and the value of the binder membrane produced during recovery. When considering cost and efficiency of separation, the solvent blend should be paired with a specific set of operational parameters for each component. These parameters will be utilized within the model, ensuring the highest level of efficacy and lowest cost for each unique input.

The solvent blend customization exhibits adaptability for proficiently processing the predominant cathode materials, including lithium iron phosphate (LFP), nickel manganese cobalt (NMC), nickel cobalt aluminum (NCA), and lithium cobalt oxide (LCO). In doing so, it preserves the integrity and electrochemical performance of the CAM. The customization framework can consider over thirty physical and chemical properties for the electrodes, their constituents, and the solvents, thereby ensuring an exhaustive and nuanced approach which returns the maximum possible value. The efficiency is quantified not only by the percentage of CAM recovered but also by the electrochemical performance of the recovered material relative to its virgin state. The predictive power of the underlying models and modularity of machine design ensure seamless integration into diverse manufacturing setups and accommodation of fluctuating production yields.

The customization, which may be referred to as a solvent-based direct recycling method, integrates a multifaceted model-based approach to address the high variability across different manufacturing scrap materials. The method focuses on the full scope of the recycling process. The customization details include tailored solvent blends, modifiable mechanical designs, and high-value solvent recovery. The economic value can be adapted to the varying yields encountered in battery production lines.

The customization of solvent blends, such as for cathode scrap recycling, can employ a multi-model computational approach. In determining the customization across categorically disparate objective functions, a combination of genetic optimization algorithms, Bayesian optimization, transfer learning, ensemble methods, and Monte Carlo simulations can be used at various stages. These models are designed to accommodate the diversity of manufacturing procedures and the variability inherent in the electrode compositions. Some properties and parameters that could be input to the model are disclosed elsewhere herein.

The primary model structures can be trained on data from an array of sources, including experimental results, molecular dynamics simulations, and material characterizations data. These data will undergo preprocessing tailored to each source and be reintroduced into relevant model training datasets. The model outputs can include customized solvent blends, operational parameters, and associated removal ratio. The performance of the customized solvent blends, particularly the efficiency of active material recovery and impurity profiles, can then be compared against the predicted outcomes. Any deviations can be used to correct model parameters for subsequent iterations, reinforcing the learning of the model through a robust feedback loop. Reliable outputs regarding separation can be further paired with the model-generated solvent recovery procedure. The separation results can be supplemented with data on the quality of the recovered binder membrane and then fed back into the model.

Given the complexity of interactions between the various electrode properties, and the extensive solvent selection criteria, the model can account for numerous constraints. The electrode variations, which affect solvent selection, are catered to by the model, ensuring adaptability across manufacturer-specific characteristics. This adaptability is key to the scalability, such as for integration within battery manufacturing facilities.

With further reference to FIG. 1, a customization method 30 is shown therein. A variety of inputs are fed into a model development step 32, which model development step then feeds output information for a solvent composition development step 34 and a machine design development step 36.

The solvent composition development step 34 can generally proceed according to the solvent customization details disclosed elsewhere herein. Other details are also provided relative to step 34. The details disclosed here relative to step 34 can also be applied generally to other solvent blend generation, such as for the methods 70, 90.

The solvent blend composition should be adapted based on the specific material to be recycled, and may also account for the particular machine assembly which is utilized. Also, the type of binder used to make the electrode affects the solvent types, in addition to the desired separation time and temperature. And the type of electrode active material will affect the blend formulation. Some electrode active materials, such as nickel rich NMC (lithium nickel manganese cobalt oxide) are more prone to damage with some types of solvent. The solvent blend composition may include anti-corrosive additives such as sodium molybdate, potassium molybdate, sodium phosphate, zinc phosphate, amine-based compounds, and the like, in order to protect the corresponding machine and the electrode active materials.

As mentioned above, the developed solvent may also depend on component selection for the machine design development step 36, which step 36 is itself based on end user (e.g., manufacturer) requirements (i.e., step 38). For example, two facilities could have identical profiles for a battery material to be recycled, but one facility needs the system to fit in a much smaller footprint. This would call for more compact components which may work better with some solvent blends, but not as well for other solvent blends.

The solvent blend composition can be adapted based on a step 40 of developing a solvent database. Exemplary solvents for a solvent database include dihydrolevoglucosenone (Cyrene), dimethylsulfoxide (DMSO), N-methyl-2-pyrrolidinone (NMP), Rhodiasolv® PolarCleana, tetrahydrofuran (THF), triacetin, triethyl phosphate (TEP), ethylene glycol (EG), acetyl tributyl citrate (ABTC), triethylene glycol diacetate (TEGDA), methyl ethyl ketone (MEK), propylene carbonate (PC), γ-Butyrolactone (GBL), dimethyl isosorbide (DMI), benzyl alcohol, isopropyl palmitate, ethyl laurate, glycerol, diacetin, sodium dodecyl sulfate (SDS), sodium lauryl sulfate (SLS), and dimethyl ethylsuccinate. In one or more embodiments, the solvent database step 40 utilizes twenty or fewer solvents in the database based on a desire to limit the model input for model step 32 to a limited less. In one or more embodiments, the selection of the twenty or fewer solvents for the database can be selected from about 150 potential solvents.

The solvent blend composition can be adapted to utilize different proportions of certain solvents for different battery material compositions. This would include tailoring the desired properties for the solvent to the particular battery material composition. Each solvent has its own properties and the desired properties can be obtained by the right combinations and proportions of solvents. This further relates to the specific mechanism of action provided by each solvent and the influence of each solvent on the emergent properties of the solvent blend as a whole. Each solvent contributes to the separation efficiency of the blend through a variety of mechanisms. Exemplary mechanisms include directly solubilizing the binder, increasing or decreasing net viscosity or molecular volume, and inhibitory binding between components. Ethylene glycol, for example, is not very good at dissolving PVDF by itself, but ethylene glycol is good at disrupting the intermolecular bonds between the PVDF and the aluminum foil. When ethylene glycol is paired with a more powerful solvent of PVDF, it can help to peel off the CAM from the aluminum foil, giving the powerful solvent more surface area to act on, increasing the overall performance.

For further analysis of a particular solvent composition, the model step 32 will be looking for a solvent or solvent blend that can solve the binder in minimal time and at minimal temperature. The model step 32 will also seek blend properties which will allow the solvent to be recovered easily, and the solvent and binder to be separated so that the solvent can be returned back to the process. The customized solvent blend 32 from model step 32 should have one or more of these characteristics: (a) easily solve binder to separate electrode active materials from the current collector and from each other (separating electrode active material particles from each other) at the minimum time and operating temperature, (b) be recovered easily with minimum process requirement, time, and temperature, (c) do not affect the electrode active material structure, morphology, and performance, (d) is not toxic and is environmentally friendly, and (e) safe and easy access.

A solvent blend for model step 32 can also be judged by its separation efficiency, output CAM quality, and the temperature and time required to achieve that level of removal. Said another way, the separation efficiency relates to what percentage of the CAM that was provided would be able to be reused and how much energy would be consumed in the process. Many different blends with different compositions might perform comparably for any given electrode. This customization can be conducted by inputting a couple basic material properties of the PVDF and solvents into model step 32.

The model step 32 and overall method 30 should also adhere to the multitude of rigorous user/manufacturer requirements from step 38, which might necessitate a second round of customization for step 32. Examples of properties for step 38 based on user/manufacturer include cost, quality, throughput, footprint, and uptime. Cost relates to the price the user/manufacturer is willing to pay per ton of CAM returned. Quality relates to limits on impurities or degradation acceptable relative to new CAM. Throughput relates to average electrode processing capacity needed per day. Footprint relates to total floorspace available for the machine and its operation. Uptime relates to desired duration of continuous operation per week.

Further aspects of step 32 include solvent selection criteria, which can include primary criteria and secondary criteria. Examples of primary criteria for solvent selection of step 32 include Hansen solubility parameters (HSP's) (e.g., δD, δP, δH), solubility, M_{W}/M_{V}, boiling point (BP)/vapor pressure (VP), viscosity profile, toxicity, and dipole moment. Examples of secondary criteria for solvent selection of step 32 include compatibility, miscibility, volatility, pH, solvent group, structure, and surface tension.

As mentioned above, the type of electrode active material will affect the blend formulation in step 32. This may be referred to as an electrode property input step 42. Examples of properties for step 42 based on overall properties include battery module (BM) composition and packing factor. Examples of properties for step 42 based on the cathode active material (CAM) include chemistry (e.g., type, combinations), additives (e.g., dopants, coatings), and sensitivity (e.g., chemical, thermal, mechanical). Examples of properties for step 42 based on the current collector of the battery include morphology, coatings, and thickness.

As mentioned above, the properties of the binder (e.g., PVDF) will affect the blend formulation in step 32. This may be referred to as a binder property input step 44. Examples of properties for step 44 based on the binder (e.g., PVDF) include Hansen solubility parameters (HSP's) (e.g., δD, δP, δH, R₀), crystallinity, polarizability, structure, viscosity, M_{W}/M_{N}, composition, and dielectricity.

Steps 36 and 46 are now further described. The mechanical system should be designed to implement the solvent blend while abiding by the widely varying, yet stringent, limitations and requirements given by each user/manufacturing facility. The method 30 and corresponding mechanical system 50 should be capable of addressing any changing priorities of each user/manufacturer.

The electrode scrap is first provided in a step 52. The other key operational stages of mechanical system 50 are shown in FIG. 2, and include size reduction 54, mixing 56, sieving 58, filtration 60, and precipitation 62. These stages are the most basic steps necessary for the efficient and sustainable extraction of cathode active material (CAM) from cathode electrode scrap generated at various stages of lithium-ion manufacturing. Material inputs and outputs of each system 50 include cathode active material (CAM), polymeric binder (PVDF), conductive additive (CA), and aluminum foil current collector (CC).

The customization of system 50 begins with categorizing components in step 46, which may be referred to as a component input step 46, based on which tasks they complete. The five major tasks can be broken down into various subtasks. The tasks can be given key subtasks, and the tasks and subtasks can be determined for which components will satisfy the tasks and subtasks. An example of subtasks includes heating and stirring for the mixing task. Another example of subtasks includes drying the aluminum foil current collector (CC) and drying the other components. The tasks and subtasks can be given metrics of performance. Exemplary metrics include throughput (kg/hr), energy consumption (kWh/kg), and size (m³). Further examples of properties for step 46 based on a component database include cost, power, size, throughput, primary task, and subtask. As mentioned above, the developed solvent may also depend on the component selection 46 for the machine design development step 36. The component input step 46 may rely on a component database.

The component database may further include categorization by accessory components. Main accessory components can include solids holding, liquid holding, solids transfer, and liquid transfer. The solids holding component can be broken down into pre-shred, pre-mix, and post-filter. The liquids holding component can be broken down into pre-mix, pre-filter, post-filter, and long term.

The mechanical components should be considered relative to the practicality and economic value to a user/manufacturer. There is a wide range of requirements (like footprint and throughput) between users/manufacturers, and even between different facilities. Moreover, two components which perform the same function can have very different effects on the solvent's interactions based on their specific operating principles. In order to flexibly meet requisite criteria regarding the physical system while delivering consistent performance, the model step 32 should account for all the contributing variables across the manufacturer's material, solvent properties, and component contributions.

Relative to step 36 and system 50, development of any given step 36 and system 50 may have a variety of solutions, in order to match a variety of other properties of the battery material and solvents. For example, a number of products exists for size reduction step 54, such as shredders granulators, mills, crushers, and grinders. Standardization of performance metrics permits easy comparison between product categories and specific models developed in step 32. Additionally, some components may perform more than one of the five major tasks (i.e., steps 54, 56, 58, 60, 62). For example, a mixer with sufficient power and adequate attachments can tear the electrode into manageable size without assistance from a shredder. In the case of a Nutsche filter-dryer, the grinding action of the mixing blade and integrated self-discharging screen can complete the tasks of size reduction, mixing, and sieving all in one component. A thorough, standardized component database from step 46 should be utilized in order to make an accurate comparison of a component's performance and the effect on method 30 (e.g., step 36) and system 50 as a whole. Each operational stage (i.e., steps 54, 56, 58, 60, 62) has many components which could adequately perform the function. Determining the customized combination of components requires a deep understanding of the interaction of the solvent blend with the electrode material, in addition to the compatibility with the user/manufacturer requirements. The objective of the component selection step 46 for step 32 is to determine which system configuration best meets the needs of a facility and the modifications required as those needs change over time.

Further details are now provided for the five major tasks (i.e., steps 54, 56, 58, 60, 62). The associated inputs and outputs, and the purpose or desired goal (i.e., function), are provided for each task. For size reduction 54, the input is scrap electrode, the output is standardized size electrode scraps, and the function is to convert scrap from various stages of manufacturing to a standard size. For mixing 56, the input is a cut electrode scraps and solvent blend, the output is solvent/binder (e.g., PVDF) solution, cathode active material (CAM) suspended in solution, and clean aluminum current collectors, and the function is to combine the scraps with the solvent blend under desired parameters to dissolve the binder and release the CAM from the current collector (CC). For sieving 58, the input is a suspension which includes the current collectors, the outputs are a solution/CAM suspension (which is transferred to the next step) and current collectors (which are separated out), and the function is to separate aluminum foil CC from the solution with suspended CAM with high efficiency. For filtration 60, the input is a mixture of solution and CAM, the outputs are solution (which is transferred to the next step) and CAM (which is separated out), and the function is to separate suspended CAM from binder/solvent solution. For precipitation 62, the input is binder/solvent solution, the outputs are solvent (which is transferred to the next step) and binder (which is separated out), and the function is to recover the solvent blend by separating the binder (e.g., PVDF) via precipitation.

As shown in FIG. 1, the solvent composition development step 34 and machine design development step 36 can be fed into, or used in conjunction with, a step 48 of developing operating parameters. When considering cost and efficiency of recycling battery materials, the overall system 30 should pair each particular solvent blend from step 34, and each machine development step 36, with a specific set of operational parameters in step 48. The operational parameters should also be considered relative to model step 32, to ensure the highest level of efficacy and lowest cost for each unique input.

Certain operating parameters which may be considered in step 48 are now disclosed. For size reduction 54, operating parameters can include power (HP), rotational speed (RPM), and output size (cm). For mixing 56, operating parameters can include temperature (deg C), mixing rate (RPM), solvent-electrode ratio, and time (hours). For sieving 58 and filtration 60, operating parameters can include mesh size (μm), first-pass efficiency (%), and pressure (psi).

In addition to the various details disclosed herein for method 30, other details are provided here relative to user/manufacturing process steps which may vary between facilities which may affect method 30 and the corresponding recycling system. Inputs such as PVDF, battery modules (BM), and cathode active materials (CAM) should be considered. The BM composition may include considering the ratio of active material (AM):PVDF:conductive additive (CA). Cathode active materials may include considering the type, purity, and size distribution. User/manufacturing process steps may include considering a mixing step. The mixing may include considering time, speed, solvent (e.g., NMP):BM ratio, and dispersion/uniformity. User/manufacturing process steps may include considering a coating or calendaring step. The coating or calendaring step may include considering density and thickness (derived width, wt. %), compaction (vol. %, force), and form factor/spacing. User/manufacturing process steps may include considering a drying step. The drying step may include considering time, temperature, and evaporation efficiency/profile. Other overall aspects which may be considered for user/manufacturing process steps may include required tolerances/purities and scrap rate/efficiency.

The overall method 30 is designed to identify the most cost-effective combination of machinery that meets the specific requirements set by the manufacturer. The modeling approach processes the wide variety of variables used to describe each component and derives one key metric: the average cost to produce a kilogram of cathode active material which is purchased back by the manufacturer ($/kgCAM). This metric synthesizes complex component attributes and performance data into a singular, actionable figure that provides guidance in decision-making.

The overall method 30 and the databases thereof should include and categorize both component-specific metrics such as upfront cost, maintenance cost, energy consumption, and operational lifespan, as well as task-specific metrics, such as the diameter and height for mixing bowls or power draw and RPM range for mixers. Each metric can be factored into $/kgCAM by introducing the predicted performance characteristics of the solvent blend which is output by the solvent selection model 32. This process can quantify and calculate the energy consumption for a given residence time and the amortization of all hardware costs over the expected lifetime capacity of the components.

The model can customize for the lowest $/kgCAM, such as by optimizing for the lowest $/kgCAM, while adhering to manufacturer-defined constraints such as throughput, quality, and operational footprint. This ensures maximum financial return and compliance with specific manufacturing requirements. The model should be dynamic, with a feedback mechanism that incorporates field data to refine the $/kgCAM calculation. This ensures that the model evolves with real-world usage, enhancing the accuracy of future component selections and overall system designs.

In light of the foregoing, it should be appreciated that the present invention significantly advances the art by providing improved systems and methods for lithium-ion battery recycling. While particular embodiments of the invention have been disclosed in detail herein, it should be appreciated that the invention is not limited thereto or thereby inasmuch as variations on the invention herein will be readily appreciated by those of ordinary skill in the art. The scope of the invention shall be appreciated from the claims that follow.

1. A method of recycling lithium-ion battery material, the method comprising steps of
providing the lithium-ion battery material, the lithium-ion battery material having a variety of properties;
reducing the size of the lithium-ion battery material;
mixing, after the step of reducing the size, the lithium-ion battery material with a solvent, wherein the solvent is customized via a model, wherein the variety of properties of the lithium-ion battery material are inputs for the model;
separating the solvent from the lithium-ion battery material; and
collecting a product following the step of separating the solvent, wherein the product is a component of the lithium-ion battery material.

2. The method of claim 1, wherein the separating the solvent comprises steps of sieving, followed by filtrating, and followed by precipitating.

3. The method of claim 1, wherein the product comprises either black mass or electrode active material.

4. The method of claim 1, wherein the lithium-ion battery material comprises electrode scrap material, wherein the step of reducing the size produces standardized size electrode scrap material.

5. The method of claim 1, wherein the lithium-ion battery material comprises whole battery modules, wherein the step of reducing the size is a step of shredding.

6. The method of claim 1, wherein the solvent is selected from dihydrolevoglucosenone (Cyrene), dimethylsulfoxide (DMSO), N-methyl-2-pyrrolidinone (NMP), tetrahydrofuran (THF), triacetin, triethyl phosphate (TEP), ethylene glycol (EG), acetyl tributyl citrate (ABTC), triethylene glycol diacetate (TEGDA), methyl ethyl ketone (MEK), propylene carbonate (PC), γ-Butyrolactone (GBL), dimethyl isosorbide (DMI), benzyl alcohol, isopropyl palmitate, ethyl laurate, glycerol, diacetin, sodium dodecyl sulfate (SDS), sodium lauryl sulfate (SLS), dimethyl ethylsuccinate, and combinations thereof.

7. The method of claim 6, wherein the model includes selecting a solvent blend from a database of solvents, wherein the database of solvents includes over twenty total solvents, wherein the model selects up to five solvents of the over twenty solvents for the solvent blend.

8. The method of claim 1, wherein user requirements are inputs for the model, wherein the user requirements comprise cost, quality, throughput, footprint, uptime, and combinations thereof.

9. The method of claim 1, wherein components of the machine assemblies which perform the steps of reducing the size, mixing, and separating are inputs for the model.

10. A method of recycling lithium-ion battery material, the method comprising steps of
providing the lithium-ion battery material, wherein the lithium-ion battery material includes a first component with a relatively lower density and a second component with a relatively higher density;
combining the lithium-ion battery material with a heavy liquid, wherein the heavy liquid has a density in between the relatively lower density and the relatively higher density, such that the heavy liquid is in between the first component as an upper product and the second component as a lower product; and
collecting the first component as the upper product and collecting the second component as the lower product.

11. The method of claim 10, wherein the lithium-ion battery material comprises black mass, wherein the first component with the relatively lower density comprises anode active material, wherein the second component with the relatively higher density comprises cathode active materials.

12. The method of claim 11, wherein the heavy liquid comprises lithium heteropolytungstate (LHPW) (Li₆H₂[PW₁₂O₄₀]), zinc chloride (ZnCl₂), sodium polytungstate (STP) (Na₆[H₂W₁₂O₄₀]), sodium iodide (NaI), or combinations thereof.

13. The method of claim 11, wherein the heavy liquid comprises sodium iodide (NaI), barium sulfate (BaSO₄), strontium carbonate (SrCO₃), or combinations thereof.

14. The method of claim 10, wherein the lithium-ion battery material comprises different cathode active materials, wherein the first component with the relatively lower density comprises a first cathode active material, wherein the second component with the relatively higher density comprises a second cathode active material.

15. The method of claim 14, wherein the different cathode active materials comprise LiFePO₄ (LFP), LiMn₂O₄ (LMO), LiNiCoAlO₂ (NCA), LiNiCoMnO₂ (NMC), and LiCoO₂ (LCO) (ρ=5.05 g/cm³).

16. The method of claim 15, wherein the heavy liquid comprises multistage heavy liquid separation steps utilizing barium sulfate (BaSO₄), strontium carbonate (SrCO₃), bismuth subnitrate (Bi₅O(OH)₉(NO₃)₄), and Clerici Solution (mixture of thallium malonate (TlC₃H₃O₄) and thallium formate TlHCOO).

17. The method of claim 10, wherein the heavy liquid is diluted by water, other solvents, other dilutants, or combinations thereof.

18. The method of claim 10, wherein the lithium-ion battery material is produced by a system comprising components of a shredder, an eddy current separator, a mixer, a vibrating conveyor, and a filter press.

19. The method of claim 10, wherein the lithium-ion battery material is produced by a system comprising components of a shredder, a mixer, a vibrating table, and a filter press.

20. The method of claim 1, wherein the method occurs within a modular recycling assembly, a battery manufacturing facility, or a combination thereof.

21. (canceled)
